(19) United States
(12) Patent Application Publication
(10) Pub. No.: US 2015/0204752 A1
(43) Pub. Date: Jul. 23, 2015

(54) METHOD FOR DETECTING AT LEAST ONE VARIABLE ASSOCIATED WITH THE FORMATION OF AT LEAST ONE JOINT AND/OR A MACHINE DURING ASSEMBLY OF A PIPELINE SYSTEM

(71) Applicant: NATIONAL OILWELL VARCO, INC., Houston, TX (US)

(72) Inventor: Kenneth Miller, Houston, TX (US)

(73) Assignee: NATIONAL OILWELL VARCO, L.P., Houston, TX (US)

(21) Appl. No.: 14/405,864

(22) PCT Filed: Jun. 6, 2013
(86) PCT No.: PCT/US2013/044620

§ 371 Date: Dec. 5, 2014

Related U.S. Application Data
(60) Provisional application No. 61/656,514, filed on Jun. 6, 2012.

(51) Int. Cl. G01M 3/18; G08B 21/18

(52) U.S. Cl. CPC G01M 3/183; G08B 21/18

(57) ABSTRACT

The present disclosure is directed to a method of detecting at least one variable associated with at least one joint or a machine of an assembled pipeline system (100). The example method includes assembling, via the machine having at least one pulling cylinder, at least two pipe sections to form at least one joint of the assembled pipeline system. The example method includes measuring, by at least one sensor (102,104), at least one variable selected from the group consisting of time, temperature and hydraulic pressure of the pulling cylinder during assembly of the pipelines system (100). The example method includes determining a location of the at least one joint of the assembled pipeline system. The example method includes recording a serial number associated with each of the at least two pipe sections of the assembled pipeline system. Corresponding systems and a computer-readable media are also disclosed.

### RELATED APPLICATIONS

This application claims priority to U.S. Provisional Patent Application No. 61/656,514, filed 6 Jun. 2012, the contents of which are incorporated herein by reference in their entirety.

### FIELD

The present embodiments relates generally to detecting at least one variable associated with the formation of at least one joint and/or a machine during assembly of a pipeline system.

### BACKGROUND

1. Technical Field

The present disclosure relates to pipeline systems and more specifically to detecting and tracking variable data associated with the formation of joints of an assembled pipeline system, and to archiving and subsequently retrieving the variable data at a later date in the event of a failure.

2. Introduction

Pipeline systems are used for transfer of various industrial fluids, such as oil, coolant, lubricants, water, or other fluids. Given the relatively large size and weight of such industrial pipeline systems, assembly of industrial pipeline systems typically occurs at remote locations that are convenient to processing facilities, such as rural fields for oil drilling, deep ocean floors, etc. Additionally, these pipeline systems are typically situated at locations that alternatively support both origination and receipt of shipment of such industrial commodities, such as ports supporting transport by truck, railway, and water shipment.

Such pipeline systems typically include an assembly of individual pipe sections, which are assembled by hydraulically pulling a pipe section having a pin end into another pipe section having a bell end, thereby creating an interference fit at the joint. Manufacturers will typically supply these pipe sections with some form of unique part identifier, such as a pipe section serial number, and these pipe sections will be delivered to a particular geographic location for subsequent on-site pipeline assembly.

Numerous environmental variables or pipeline system assembly parameters can influence its mechanical outcome and performance, as well as the resulting physical integrity of such assembled pipeline systems. Such variables can include, for example, any combination of one or more of variations in mechanical tolerances associated with the respective pin end and bell end of mating pipe sections, ambient temperature and humidity conditions at time of assembly, hydraulic pressing or pulling forces generated by pipeline assembly equipment while mating the pipe sections, as well as other variations affecting pipe quality or reliability.

Because of the remote locations where these pipeline systems are typically assembled and deployed for use, experienced or qualified machine operators and related equipment are frequently unavailable. Given the complex nature and enormous capital expense for installation of such pipeline systems, as well as the high value associated with the commodities potentially being piped therein, it is desirable that such pipeline systems perform for several years without failure or required maintenance. Thus, determining whether the interference fit is proper during the pipeline assembly process and that a fluid-tight joint is established before these resources leave the pipeline assembly location can be important.

In the event of a pipeline system failure, such as a failed connection (i.e., leakage) between a particular pin end and bell end of adjacent pipe sections, establishing some form or archival record during original assembly which documents the various assembly parameters and variables may be desirable. This would allow for both dynamic and retrospective analyses of the pipeline.

Therefore, a need exists for detecting and tracking multiple variables associated with the formation of at least one joint of an assembled pipeline system at the time of assembly. A need also exists for archiving and subsequently retrieving variable data associated with the formation of at least one joint at a later date in the event of a subsequent failure of the at least one joint. The embodiments described below are believed to meet these needs.

### SUMMARY

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein. The steps outlined in these methods can be arranged in any order, combination, or permutation thereof. The methods can include fewer steps or more steps.

Disclosed herein is a method of detecting at least one variable associated with at least one joint and/or a machine of an assembled pipeline system. A system configured to practice this method can assemble, via the machine including at least one pulling cylinder, at least two pipe sections to form at least one joint of the assembled pipe system. The system can measure, by at least one sensor, at least one variable selected from the group consisting of time, temperature and hydraulic pressure of the pulling cylinder during assembly of the pipe system. The system can determine a location of the at least one joint of the assembled pipeline system. The system can record a serial number associated with each of the at least two pipe sections of the assembled pipeline system.

In another aspect, a system for detecting at least one variable associated with at least one joint and/or a machine of an assembled pipeline system, includes a machine including at least one sensor for measuring at least one of a variable selected from the group consisting of time, temperature and hydraulic pressure of a pulling cylinder during assembly of the pipe system. The system can include a data controller communicatively coupled to the at least one sensor, the data controller configured to receive information from the sensor. The system can include a processor for executing computer-executable instructions for analyzing information obtained from the data collector.

Also disclosed herein is a non-transitory computer-readable medium for use on a computer system, the computer-readable medium including computer-executable instructions for performing, when executed by a processor, a method for detecting at least one variable associated with at least one joint and/or a machine. The method can include receiving a measurement, via at least one sensor, of at least one variable selected from the group consisting of time, temperature, and hydraulic pressure during assembly of a pipe system. The method can include determining a location of at least one joint. The method can include generating a notification, status, or alert regarding the received measurement.

### BRIEF DESCRIPTION OF THE DRAWINGS

Various embodiments of the invention will be understood from the following description, the appended claims and the accompanying drawings, in which:

FIG. 1 provides a schematic diagram of a working environment of the present invention.

FIG. 2 provides a schematic diagram illustrating certain components associated with the embodiments of FIG. 1; and

FIG. 3 provides a flowchart depicting an exemplary method for detecting at least one variable, consistent with the disclosed embodiments of FIGS. 1-2.

### DETAILED DESCRIPTION OF THE EMBODIMENTS

Before explaining the present embodiments in detail, it is to be understood that the embodiments are not limited to the particular embodiments and that they can be practiced or carried out in various ways. The steps and modules outlined and illustrated herein are exemplary, and can be combined in multiple configurations, including configurations in different orders, with different functional links, or with more or fewer steps or modules.

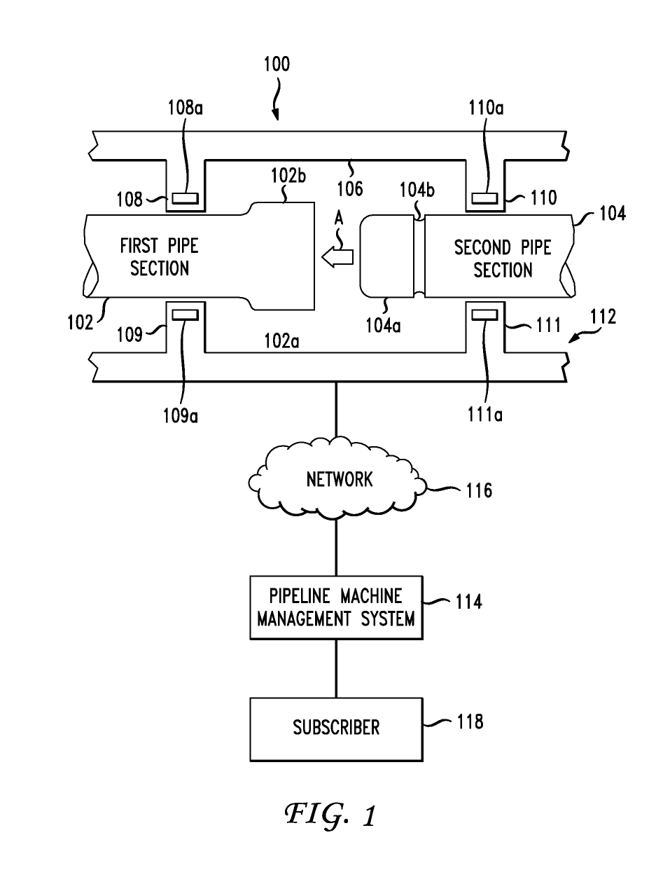

FIG. 1 illustrates pipeline assembly equipment 100 for assembling a first tubular pipe section 102 together with a second tubular pipe section 104. While the examples provided herein refer to tubular pipe sections 102, 104, the same principles can be applied to other, non-tubular pipe sections as well, including but not limited to square, rectangular, octagonal, or trigonal pipes. These pipe sections will be typically be fabricated with specially-formed, mating ends for assembly by interference fit, and will be shipped in such form to the site for assembly using the present invention. The pipe sections can be fabricated of any suitable material, including but not limited to steel, ductile iron, PVC, non-rigid plastic, copper, and other materials.

In one example, the first pipe section 102 incorporates an expanded bell end 102a, and further includes an interior region 102b defined within the bell end. Prior to assembly of the two pipe sections, the interior region 102b may be coated with a fast setting epoxy compound, or other adhesive material or materials, disposed along its interior surface, which can include a smooth powder fusion epoxy, or alternatively can include a multi-layer (e.g., three-layer) polyethylene coating.

The second pipe section 104 incorporates a pin end 104a which is tapered inwardly at the tapered portion 104b in order to provide a mating seal with the interior region 102b of the first pipe section 102. Adjacent the pin end 104a, an annular groove 104b may be pre-formed into the outer surface of the second pipe section, such as by a hydraulic groover or otherwise machined into the pipe, in order to receive additional epoxy for an improved fluid seal following pipe assembly. The pin end 104a may be coated with a fast setting epoxy compound disposed along its interior surface, which can include a smooth powder fusion epoxy, or alternatively can include a multi-layer (e.g., three-layer) polyethylene coating. However, it may be desirable that the most distal portion of the pin end 104a remains partially uncoated with the polyethylene coating to optimize the coupling of the first and second pipe sections.

The pipe assembly equipment 100 includes a housing 106. The housing incorporates inwardly-projecting pipe guides 108 and 109 which can be positioned after insertion of the bell end 10 of the first pipe section 102 into the housing, to stabilize the first pipe section for assembly. Additionally, the housing incorporates inwardly-projecting pipe guides 110 and 111 which can be positioned after insertion of the pin end 10 of the second pipe section 104 into the housing, to stabilize the second pipe section for assembly.

Additionally, each of the projecting pipe guides 108, 109, 110 and 111 are respectively provided with sensors 108a, 109a, 110a and 111a, for purposes of monitoring and acquiring at least one of several variables representative of pipe assembly conditions, including without limitation, hydraulic pressing or pulling forces generated by pipe assembly equipment while mating the pipe sections, time of assembly, and the like. Additionally, these sensors may also monitor and acquire at least one of several variables representative of pipe assembly conditions in the environment during pipeline installation, including without limitation, ambient temperature, barometric pressure and humidity conditions at time of assembly, and the like. The sensors can be incorporated into the projecting pipe guides 108, 109, 110, and 111, or can be incorporated at other locations, such as the exterior surface of the housing 106, within the pipe sections 102, 104, or in the cavity within the housing 106 between the projecting pipe guides 108, 109, 110 and 111. In one embodiment, the sensors are of different types. In another embodiment, multiples sensors of a same type at several positions or locations can detect a difference or a gradient in sensed values.

During assembly, the first pipe section 102 and the second pipe section 104 are concentrically aligned within the housing 106 of the pipe assembly equipment 100 with respect to a common longitudinal axis, and are stabilized by the pipe guides 108, 109, 100 and 111, to ensure effective assembly at the mating joint.

As a result, the pin end 104a is inserted into the bell end 102a, such as by a hydraulic press (not shown), or in the alternative a hydraulic pulling cylinder (not shown), which moves the pin end in the general direction depicted by arrow A toward the bell end. In this manner, the two pipe sections are coupled together to create an interference fit. When in an interference fit, the interior surface of the bell end 102a exerts a compressive force upon the exterior surface of the pin end 104a, which force is engineered by choice of design and materials to be less than the yield strength of the pin end.

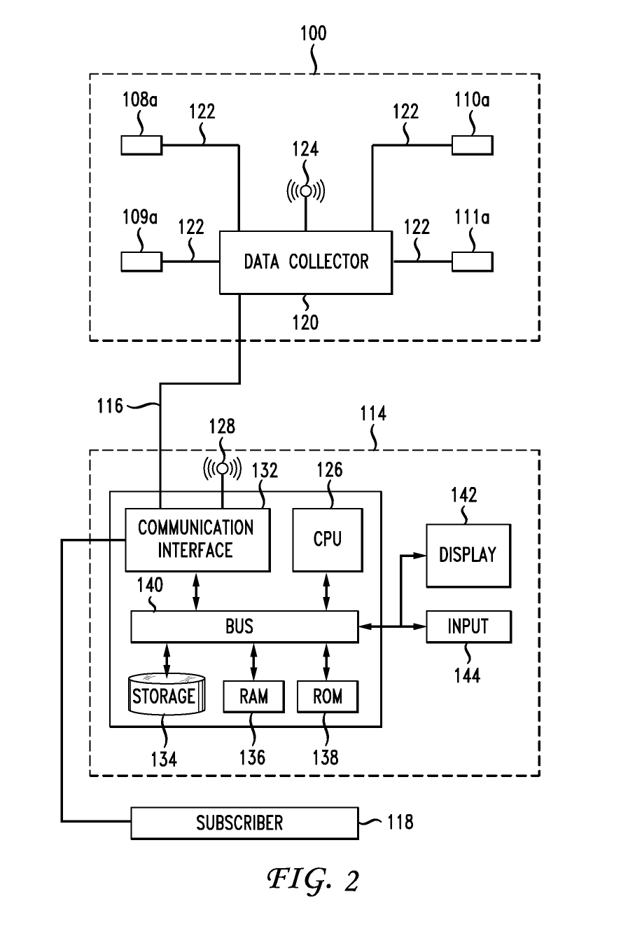

The pipeline assembly equipment 100 is illustrated in FIG. 1 as being situated in an environment 112 for assembly and installation of pipeline systems, and is coupled to a pipeline machine management system 114 via a wired or wireless network 116. In one example, the sensors 108a, 109a, 110a and 111a communicate with a central data collector, discussed below with respect to FIG. 2, which gathers the sensor data and reports the sensor data to the pipeline machine management system 114.

The subscriber 118 is depicted as connected to the pipeline machine management system 114, to receive updates on information being acquired during pipeline assembly, as hereinafter described below. Subscriber 118 may be one or more entities with an interest or stake in the performance or electromechanical condition of pipeline assembly equipment 100, and the subscriber may have duties or responsibilities to maintain the performance of or condition of pipeline assembly equipment 100. Subscriber 118 may receive information on the at least one variable, such as the hydraulic pressure of the pulling cylinder (not shown) on pipeline assembly equipment 100. Subscriber 118 may receive the information from pipeline machine management system 114. Subscriber 118 may include, for example, operators of pipeline assembly equipment 100, project managers, repair technicians, shift managers, human resource personnel, or any other person or entity that may be designated.

In one variation, the subscriber 118 is a human entity, but the subscriber 118 can also be an electronic repository, such as a log file or a pipeline machine management history or record repository. The log file can include information such as a date, time, sensor readings, serial numbers of the pipe sections, sensor status, or any other available and relevant information. The subscriber 118 can enroll with the pipeline machine management system 114 to receive notifications of sensor data that exceeds a threshold, such as a sensed temperature outside of a desired temperature range for safe operation of the resulting pipe joint. Thus, while the pipeline machine management system 114 can record a large set of data, which can be made available upon request of the subscriber 118, the pipeline machine management system 114 may only generate notifications for the subscriber 118 based on one or more conditions or sensor data ranges. The subscriber 118 can also enroll with the pipeline machine management system 114 to receive a periodic update or report of all data performed within a certain time period or within a certain number of pipe join operations, such as a daily report or a report for every 500 pipe join operations.

The location of the at least one joint associated with each such pipeline assembly can be dynamically determined. According to one embodiment, GPS or another positioning system, alone or in combination with an internal tracking system of the pipeline machine management system 114, may track or periodically update the position of pipeline assembly equipment 100. In another exemplary embodiment, RFID tags located on-board the pipeline assembly equipment 100 may be detected by RFID receivers distributed throughout work environment 112 to determine relative positions of such equipment 100. In another exemplary embodiment, a combination of GPS and RFID methodologies may be employed to determine the location of pipeline assembly equipment 100 in work environment 112. In another embodiment, unique serial numbers can be imprinted directly on the pipeline assembly equipment which can be recognized and retrieved from a database to identify the equipment 100. In yet another embodiment, some optically readable code, such as a QR code or other form of barcode, is affixed to or included on the equipment 100 for identification via an automatic means or via a human manually scanning the code, such as with a handheld barcode scanner.

As illustrated in FIG. 2, the pipeline assembly equipment 100 is connected via network 116 to pipeline machine management system 114, which is described in more detail below.

Pipeline assembly equipment 100 can further incorporate a data collector 120 which may be configured to receive, collect, package, format, and/or distribute variable data acquired by each of the respective pipe sensors 108a, 109a, 110a and 111a. In one embodiment, pipeline assembly equipment 100 may include on-board data collection and communication equipment to monitor, collect, and/or distribute information associated at least one variable sensed by at least one of the sensors 108a, 109a, 110a and 111a. In particular, pipeline assembly equipment 100 may include electronic sensors 108a, 109a, 110a and 111a and control modules that are coupled to one or more data collectors 120 via communication lines 122. Additionally, the data collector 120 may include one or more transceiver devices 124 and/or any other components for monitoring, collecting, and communicating information associated with the operation of pipeline assembly equipment 100.

Pipeline assembly equipment 100 may also be configured to receive information, warning signals, operator instructions, or other messages or commands from off-board systems, such as from pipeline machine management system 114. The components described above are exemplary and not intended to be limiting. Accordingly, the disclosed embodiments contemplate pipeline assembly equipment 100 including additional and/or different components than those listed above.

Referring to FIG. 2, pipeline machine management system 114 may include one or more hardware components and/or software applications that cooperate to improve performance of pipeline assembly equipment 100 in work environment 112 by monitoring, analyzing, and/or measuring variables during assembly of at least one joint during assembly of a pipeline system. For example, pipeline machine management system 114 may include a variable monitoring system 126 for collecting, distributing, analyzing, and/or otherwise managing variable data collected from pipeline assembly equipment 100. In one exemplary embodiment, variable monitoring system 126 may determine hydraulic pressure of at least two pipe sections during assembly of at least one joint.

Variable monitoring system 126 may include any computing system configured to receive, analyze, transmit, and/or distribute variable data associated with pipeline assembly equipment 100. Variable monitoring system 126 may be communicatively coupled to pipeline assembly equipment 100 via communication network 116. Data collector 120 may receive variable data from at least one of the sensors 108a, 109a, 110a and 111a via communication lines 122 during operation of the pipeline assembly equipment 100, and may transmit the received data to pipeline machine management system 114 via communication network 116. Alternatively or additionally, data collector 120 may store the received data in memory for a predetermined time period, for later transmission to pipeline machine management system 114. For example, if a communication channel between the pipeline assembly equipment 100 and pipeline machine management system 114 becomes temporarily unavailable, the performance data may be stored in memory for subsequent retrieval and transmission when the communication channel has been restored.

In an alternate embodiment, variable monitoring system 126 may be located on pipeline assembly equipment 100. Variable monitoring system 126 may embody a centralized server and/or database adapted to collect and disseminate variable data associated with forming at least one joint of the assembled pipeline system and/or pipeline assembly equipment 100.

Variable monitoring system 126 may include hardware and/or software components that perform processes consistent with certain disclosed embodiments. For example, as illustrated in FIG. 2, variable monitoring system 126 may include one or more transceiver devices 128, a central processing unit (CPU) 130, a communication interface 132, one or more computer-readable memory devices, such as a storage device 134, a random access memory (RAM) 136 and a read-only memory (ROM) 138, a common information bus 140, a display unit 142, and/or an input device 144. The components described above are exemplary and not intended to be limiting. Furthermore, variable monitoring system 126 may include alternative and/or additional components than those listed above.

CPU 130 may be one or more processors that execute instructions and process data to perform one or more processes consistent with certain disclosed embodiments. For instance, CPU 130 may execute software that enables variable monitoring system 126 to request and/or receive variable data from data collector 120 of pipeline assembly equipment 100. CPU 130 may also execute software that stores collected variable data in storage device 134. In addition, CPU 130 may execute software that enables variable monitoring system 126 to analyze variable data collected from pipeline assembly equipment 100, perform diagnostic and/or prognostic analysis to identify potential problems with the at least one joint formed from at least two pipe sections, notify a machine operator or subscriber 118 of any potential problems, and/or provide customized analysis reports.

CPU 130 may be connected to a common information bus 140 that may be configured to provide a communication medium between one or more components associated with variable monitoring system 126. For example, common information bus 140 may include one or more components for communicating information to a plurality of devices. According to one embodiment, CPU 130 may access, using common information bus 140, computer program instructions stored in memory. CPU 130 may then execute sequences of computer program instructions stored in computer-readable medium devices such as, for example, storage device 134, RAM 136, and/or ROM 136, in order to perform methods consistent with certain disclosed embodiments, as will be described below.

Communication interface 132 may include one or more elements configured for two-way data communication between variable monitoring system 126 and remote systems (e.g., pipeline assembly equipment 100) via transceiver device 128. For example, communication interface 132 may include one or more modulators, demodulators, multiplexers, demultiplexers, network communication devices, wireless devices, antennas, modems, or any other devices configured to support a two-way communication interface between variable monitoring system 126 and remote systems or components.

One or more computer-readable medium devices may include storage device 134, a RAM 136, ROM 138, and/or any other magnetic, electronic, flash, or optical data computer-readable medium devices configured to store information, instructions, and/or program code used by CPU 130 of variable monitoring system 126. Storage device 134 may include magnetic hard-drives, optical disc drives, floppy drives, flash drives, or any other such information storing device. RAM 136 may include any dynamic storage device for storing information and instructions by CPU 130. RAM 136 also may be used for storing temporary variables or other intermediate information during execution of instructions to be executed by CPU 130. During operation, some or all portions of an operating system (not shown) may be loaded into RAM 136. In addition, ROM 138 may include any static storage device for storing information and instructions by CPU 130.

Variable monitoring system 126 may be configured to analyze variable data associated with at least one joint formed by assembling at least two pipe sections. According to one embodiment, variable monitoring system 126 may include diagnostic software for analyzing variable data associated with at least one joint based on threshold levels (which may be factory set, manufacturer recommended, and/or user configured). For example, diagnostic software associated with variable monitoring system 126 may compare an ambient temperature measurement received from a particular machine with a predetermined threshold temperature. If the measured ambient temperature exceeds the threshold temperature, variable monitoring system 126 may generate an alarm and notify one or more of the machine operator, job-site manager, repair technician, dispatcher, or any other appropriate entity, such as subscriber 118.

Variable monitoring system 126 may determine a physical location for the at least one joint of the assembled pipeline system. The physical location may be determined based on monitored GPS data associated with the machine, or other positioning systems, such as an internal machine system. For example, the physical location may be determined using the latitude, longitude, and elevation of the machine derived from GPS data gathered from on-board GPS equipment. Four or more remote positioning devices (or GPS satellites) may be used to determine elevation.

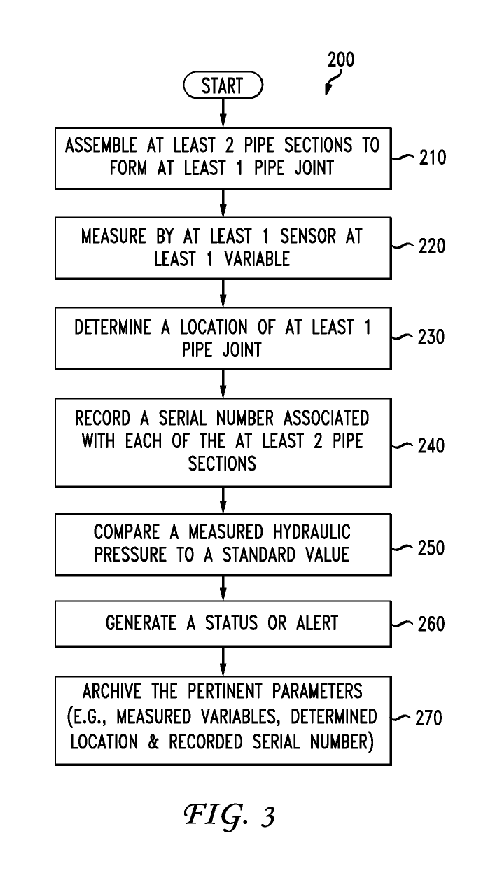

FIG. 3 provides a flowchart 200 depicting an exemplary method for detecting at least one variable, consistent with the disclosed embodiments.

As described above, the pipeline assembly equipment 100 is used to assemble a pipeline consisting of at least a first pipe section 102 and a second pipe section 104, thereby forming at least one pipe joint therebetween (Step 210).

Pipeline machine management system 114 records at least one sensor variable associated with the pipeline assembly process, such as hydraulic pressing or pulling parameters, pipeline temperature, ambient temperature, barometric pressure, humidity, time of assembly, etc. (Step 220). These measured pipeline assembly variables may be expressed as a number, a range of values around a number, a range of values between two numbers, a range of values, a maximum value, a minimum value, and the like. The range of values, for example, may include a predetermined amount or percentage of a value, or may be determined at the time the variable is measured. The range of values can be determined in advance and established in a memory, firmware, or other storage location of the system. Alternatively, an operator, administrator, or other user can enter or modify ranges of values.

The location of the at least one pipe joint associated with each such pipeline assembly can then be dynamically determined (Step 230).

A serial number associated with each of the at least two pipe sections of the assembled pipe system may then be recorded (Step 240). A subscriber 118 may use an input device 144, such as a keyboard, to enter the serial number as the pipe section are fitted to form the at least one pipe joint. The serial number can be associated with the material, location and date of manufacturer of the respective pipe sections. Alternatively, Step 240 may be performed prior to any of Steps 210, 220 and 230, or in any order therebetween.

After the variables have been acquired in Step 220, the variables are compared to standard and/or threshold values (Step 250). As an example to illustrate use of an embodiment of the present invention, the measured hydraulic pressure associated with the pulling cylinder of pipeline assembly equipment 100 can be compared to a standard hydraulic pressure, in order to determine whether the formed pipe joint, or the respectively-joined pipe sections, are faulty. For example, if the measured hydraulic pressure is greater or less than the standard value, then the data may suggest a variety of problems, such as a defect in the material of the pipe section (i.e., steel pipe section), improper dimensional tolerances in the bell and/or pin ends of the pipe sections, defective coatings or epoxy adhesives at the joint, and the like.

Variable monitoring system 126 may be configured to generate a status or alert and provide the status or alert to pipeline machine management system 114 and/or one or more subscribers 118 (Step 260). A status or alert may indicate the comparison of Step 250 was out of tolerance, or may be information, such, as for example, the hydraulic pressure of the pulling cylinder during formation of the at least one joint was normal. A status or alert may embody any type of signal or message notifying pipeline machine management system 114 and/or one or more subscribers 118 of a variable measured by at least one sensor. For example, variable monitoring system 126 may output hydraulic pressure data on a display console 142 associated with the variable monitoring system 126. Alternatively or additionally, variable monitoring system 126 may provide an electronic message (e.g., electronic page, text message, fax, e-mail, etc.) indicative of the status or alert to a respective machine operator and/or a project manager, or any other person or entity established as a subscriber 118. In response to the status notification, subscribers 118 may take appropriate responsive action to investigate the variable to ensure that the at least one joint of the assembled pipe system is properly formed.

In another embodiment, variable monitoring system 126 may be configured to archive at least one of the following, namely: the measured variables; the location of the at least one joint; the recorded serial number of each of the at least two pipe sections of the assembled pipe, and the like (Step 135). This archived data may later be retrieved in order to evaluate a cause of a latter failure of at least one joint.

While certain aspects and features associated with the method described above may be described as being performed by one or more particular components of pipeline machine management system 114, it is contemplated that these features may be performed by any suitable computing system. Also, while the method may describe variable monitoring system 126 as being part of pipeline machine management system 114, variable monitoring system 126 may instead be located on-board pipeline assembly equipment 100. Furthermore, the order of steps in FIG. 3 is exemplary only, and that certain steps may be performed before, after, or substantially simultaneously with other steps illustrated in FIG. 3.

What is claimed is:

1. A method of detecting at least one variable associated with at least one of a joint or a machine of an assembled pipeline system, the method comprising:
assembling, via the machine comprising at least one pulling cylinder, at least two pipe sections to form at least one joint of the assembled pipeline system;
measuring, by at least one sensor, at least one variable selected from the group consisting of time, temperature and hydraulic pressure of the pulling cylinder during assembly of the pipeline system;
determining a location of the at least one joint of the assembled pipeline system; and
recording respective unique identifiers associated with each of the at least two pipe sections of the assembled pipeline system.

2. The method of claim 1, wherein assembling the at least two pipe sections comprises hydraulically pulling together a bell-end of one of the at least two pipe sections and a pin end of another of the at least two pipe sections to form an interference fit.

3. The method of claim 1, further comprising comparing the hydraulic pressure to a standard value, wherein one of a higher hydraulic pressure than the standard value or a lower hydraulic pressure than the standard value indicates one of a defect in a material from which the at least two pipe sections are made or a problem with at least one of the at least two pipe sections.

4. The method of claim 1, further comprising generating an alert regarding at least one of the at least one variable.

5. The method of claim 4, wherein the further comprising generating the alert is based on the at least one variable exceeding an acceptable range of values.

6. The method of claim 1, further comprising generating a status report regarding at least one of the at least one variable.

7. The method of claim 6, wherein the status report comprises a log file.

8. The method of claim 1, further comprising archiving the at least one variable, the location, and the respective unique identifiers.

9. A system for detecting at least one variable associated with at least one of a joint or a machine of an assembled pipeline system, the system comprising:
a machine comprising at least one sensor for measuring at least one of variable selected from the group consisting of time, temperature and hydraulic pressure of a pulling cylinder during assembly of the pipeline system;
a data controller communicatively coupled to the at least one sensor, the data controller configured to receive information from the sensor; and
a processor for executing computer-executable instructions for analyzing information obtained from the data collector.

10. The system of claim 9, wherein the at least one sensor is integrated within the machine.

11. The system of claim 9, wherein the computer-executable instructions, when executed by the processor, cause the processor to generate an alert when the information obtained from the data collector exceeds an expected range.

12. A non-transitory computer-readable medium for use on a computer system, the computer-readable medium including computer-executable instructions for performing, when executed by a processor, a method for detecting at least one variable associated with at least one joint and/or a machine, the method comprising:
receiving a measurement, via at least one sensor, of at least one variable selected from the group consisting of time, temperature, and hydraulic pressure during assembly of a pipeline system;
determining a location of at least one joint; and
generating a notification regarding the measurement.

13. The non-transitory computer-readable medium of claim 12, wherein the notification comprises an alert to a user.

14. The non-transitory computer-readable medium of claim 12, wherein the notification comprises an entry in a log file.

15. The non-transitory computer-readable medium of claim 12, wherein the notification indicates the measurement of the at least one variable and the location of the at least one joint.
